(19) United States
(12) Patent Application Publication
(10) Pub. No.: US 2008/0196831 A1
(43) Pub. Date: Aug. 21, 2008

(54) METHOD OF ADHESIVELY BONDING A FIRST COMPONENT TO A SECOND COMPONENT

(76) Inventors: Carsten Friese, Duesseldorf (DE); Rainer Schoenfeld, Duesseldorf (DE); Siegfried Kopannia, Krefeld (DE); Julius Herold, Plankstadt (DE); Karel Mazac, Friedberg (DE); Christian Lammel, Ismaning (DE)

Correspondence Address: HENKEL CORPORATION, 1001 TROUT BROOK CROSSING, ROCKY HILL, CT, 06067, US

(21) Appl. No.: 12/027,418

(22) Filed: Feb. 7, 2008

(30) Foreign Application Priority Data
Feb. 7, 2007 (DE) 102007006881.8

(51) Int. Cl. B29C 65/14

(52) U.S. Cl. 156/295

(57) ABSTRACT

A method of adhesively bonding a first component to a second component, which comprises a peripheral zone with which the first component is adhesively bonded in overlapping manner is provided. In such method, a) at least one body of hot-melt adhesive is adhesively bonded to the first component in such a way that it comes into contact with the peripheral zone upon adhesive bonding of the first component to the second component, b) the peripheral zone is heated locally at at least one point, at which the applied body of hot-melt adhesive comes into contact with the peripheral zone upon adhesive bonding of the first component, indirectly or directly by electromagnetic induction to a temperature above the melting temperature of the hot-melt adhesive, c) the first component is brought into contact with the peripheral zone of the second component in such a way that the body of the hot-melt adhesive comes into contact with the point of the peripheral zone heated in step b), such that the hot-melt adhesive melts at the point of contact with the peripheral zone and bonds the first component to the peripheral zone of the second component after cooling. In addition, prior to step b) or after step c) a reactive adhesive is introduced in such a way between the first and the second component that it bonds the first component to the peripheral zone of the second component, the reactive adhesive being cured or allowed to cure.

### CROSS-REFERENCE TO RELATED APPLICATION

This application claims priority, under 35 U.S.C. Section 119, from German patent application No. 102007006881.8 filed Feb. 7, 2007, the entire disclosure of the prior application being incorporated herein by reference in its entirety.

### FIELD OF THE INVENTION

The present invention relates to an improved method of adhesively bonding a first component to a second component. In this method, the first component is adhesively bonded to the second component by means of two different adhesives. One of the adhesives is a hot-melt adhesive, with which the first component is fixed to the second component, before the second adhesive, which constitutes a reactive adhesive, cures and brings about the final strength of the adhesive bond. The first component may, for example, be a window pane for a vehicle or a vehicle part, for example the window pane of a sunroof or a front or rear windshield. However, the invention is not limited thereto.

### DISCUSSION OF THE RELATED ART

Such a method is known for example from EP 1 403 108 B1. The explanations given therein also apply to the present invention:

“Vehicle glazing is associated with a plurality of technical problems. Typically, polyurethane-based adhesive sealants are used for glazing vehicles, which require a relatively long curing time. During this curing time, the window pane used is exposed to constant vibration and shaking as it is continuously conveyed onwards as desired along a production line, which vibration and shaking may lead to the window pane slipping. Such a change in position means it does not fit accurately, so resulting in defective adhesively sealed joints and in leaks. In addition, slipping of the window pane out of its intended position may at least in places reduce the size of the remaining peripheral gap relative to the vehicle body in such a way that as to make impossible the optional fitting of a peripheral sealing lip. Furthermore, slipping of the window pane may also reduce the stability of the entire vehicle, since defects in the glazing, which functions as a load-carrying component, have an effect on vehicle statics. Moreover, partially concentrated pressure loading of the window pane during the curing process leads in particular to unevenly cured adhesive surfaces, which may lead, in an extreme scenario, to isolated lateral bulging of the adhesive sealant. For these reasons, various efforts have been made to solve or get round these stated problems.”

Stated document EP 1 403 108 B1 then cites in the introduction ways of solving these problems which have been proposed in the prior art. Building thereon, EP 1 403 108 B1 proposes the following improved method of fastening glazing to a supporting frame, which is applicable in particular to the direct glazing of vehicles:

“in this method, a first adhesive sealant preferably based on polyurethanes is used which surrounds the peripheral zone of the main window surface in the form of a strand. This may be applied to the window pane itself or alternatively to the supporting frame prior to insertion of the window pane into the supporting frame. In addition, prior to insertion of the glazing a further, second adhesive composition is applied to the window pane or alternatively to the supporting frame at least over some of the overall periphery of the stated peripheral zone. Ideally, the first adhesive sealant and the second adhesive composition are applied in such a way that they are spatially separated from one another after insertion of the window pane into the supporting frame, in order to avoid any problems of compatibility right from the outset. The second adhesive composition cures faster than the first adhesive sealant. “Cures faster” should here be understood to mean in particular curing times of less than 5 minutes, preferably of 0.5 seconds to 60 seconds, ideally of 0.5 seconds to 5 seconds, curing of the second adhesive composition preferably being capable of being initiated by a controllable external energy input. The lower time limit is here merely defined by parameters of the method and may be of any desired short duration as a function of the adhesive composition used, the intensity of the energy input, etc. In any case, the window pane is initially fixed in the desired position by selective curing of solely the second adhesive composition, which cures faster than the first adhesive sealant. This ensures trouble-free and homogeneous curing of the first adhesive sealant. The only requirement with regard to the durability of the bond between glazing and supporting frame produced by the second adhesive composition is that the latter is able to hold the window pane in the position in which it has been inserted until the first adhesive sealant has cured. However, the resilience of the bond between window pane and supporting frame produced by the second adhesive composition may ideally be adjusted to be similar to that of the bond brought about by the first adhesive sealant when cured, in order to counter undesired neutralization of the long-term resilience of the adhesive seal ensured by the first adhesive sealant.”

“In a particularly advantageous embodiment, a photocrosslinking adhesive composition is used as the second adhesive composition. A photocrosslinking adhesive composition is here and below understood to mean an adhesive composition which may be cured by irradiation with light in the wavelength range of approx. 300 nm to approx. 780 nm. The sensitivity of such an adhesive composition may thus explicitly include the UVA, UVB and/or the visible range of the spectrum.”

“In a further suitable embodiment, an adhesive composition curable by input of heat is used as the second adhesive composition. This adhesive composition is cured by means of input of heat after insertion of the window pane into the supporting frame. Heat sources which may be used are conventional radiant heaters, infrared lamps or the like.”

“In one particularly advantageous development, the heat is specifically introduced into the area of the second adhesive composition applied by means of a microwave radiator, in order in this way to ensure uniform heating of the second adhesive composition and thus initiate homogeneous curing of the corresponding bond areas.”

“In a suitable modification of the stated embodiments, a two-component adhesive composition is used, which is applied either to the supporting frame or to the window pane prior to insertion of the window pane. Preferably, this two-component adhesive composition which is used cures after mixing of the two-components in less than 5 minutes, ideally within between 5 seconds and 120 seconds. Curing of the two-component adhesive composition may of course likewise be additionally accelerated by the input of heat after application. Heat sources which may be used are conventional radiant heaters, infrared lamps or the like.”

“In all the stated embodiments it is advantageous for use of the second adhesive composition to be locally limited relative to the entire adhesive surface. Preferably, opposing (corner) points and/or edges of the window pane or of the support frame are selected for this purpose, in order to ensure satisfactory fixing of the window pane in the desired position after curing of the second adhesive composition, such that this position is no longer able to change, for example as a result of the vibration and shaking inevitably encountered on production lines.”

According to this solution proposed in EP 1 403 108 B1, the “second adhesive composition”, which is intended to produce a first quick bond between window pane and supporting frame, is thus a reactive adhesive. A similar method is also described in EP 1 475 424 A1. However, a hot-melt adhesive is used therein as the adhesive composition which is intended to produce a first quick bond. This may be applied at certain points on a module to be adhesively bonded in place, for example a window pane, immediately after production thereof. For storage and transport, this hot-melt adhesive then at the same time performs the function of a spacer. With the assistance thereof, the modules such as for example window panes may be leaned against one another or stacked on one another without touching and thereby scratching one another. EP 1 475 424 A1 states the following by way of introduction:

“Hot-melt adhesives have long been known and are widely used for example in the packaging, textiles and shoe-making industries. However, in the case of a hot-melt adhesive, as with all quick-curing adhesives, such as for example 2-component polyurethane adhesives, rapid build-up of strength is associated with a short open time. Adhesive bonding has namely to proceed within the so-called open time, which means that the user has only a very short time to apply the adhesive, position the bond partners and join them together. If pot life is exceeded, adhesive bonding is no longer possible due to inadequate wetting and/or the absence of reactive groups.”

“This is very disadvantageous in particular in the case of large-area adhesive bonding. In addition, this is likewise disadvantageous in particular in the case of metallic substrates or other substrates with good thermal conductivity.”

“Therefore, hot melts are not used in automotive construction for example as window pane adhesives. A further significant disadvantage of hot melts is that an adhesive bond, once brought about, has a tendency to creep as a result of the thermoplastic behavior of the adhesive and the strength of the adhesive bond decreases severely in particular at elevated temperatures. For this reason, hot-melt adhesives are unsuitable for producing adhesive bonds exposed to strong dynamic and in particular static loads.”

“For this reason, in industrial manufacture, in particular vehicle construction, resilient single-component polyurethane adhesives are used. However, these adhesives have the significant disadvantage of curing slowly. Until the adhesive achieves sufficiently high intrinsic strength to hold the bond partners in the desired pressure even under pressure and the application of force, the bond partners are conventionally fixed relative to one another. Such fixing is often achieved using wedges or adhesive tapes which are removed again after curing. The use of such fixing aids entails both additional labor and a risk of damage to visible surfaces.”

Building on this, EP 1 475 424 A1 describes stackable modules, which comprise at least one spacer, which is based on a hot-melt adhesive bonding agent and is applied to a surface of the module and adheres thereto. EP 1 475 424 A1 further reads verbatim:

“The described modules may be used virtually anywhere. Preferred fields of use are mechanical engineering, computer construction, consumer goods construction, in particular household machines, such as for example washing machines, cookers or coffee-making machines, dishwashers, vehicle construction, in particular bus, car, commercial vehicle or train construction.”

“Modules may be diverse assemblies composed in turn from a plurality of parts. The complexity of such modules differs greatly, for example they may comprise two partial shells fixed together or modules may have thousands of parts. Examples of such modules are spare wheel troughs, headlamp housings, rearview mirrors, drivers' cabs, control units, doors, printed circuit boards, roof modules, etc. Particularly preferred as modules are window panes of any type, in particular roof modules, windshield panes, rear windshield panes, side window pane modules.”

“The primary function of the spacer is to prevent by its spatial extent direct contact between two surfaces of at least two module surfaces stacked on one another or touching one another at the sides. Such spacers are sensibly only fitted where contact between the module surfaces is likely. The location, number and precise geometry of these spacers is dependent on module geometry and it is clear to a person skilled in the art how these should be designed so as to ensure functioning of the spacer. In a preferred embodiment, the thickness of the spacer is the same size or slightly larger than the intended thickness of adhesive between the module and a surface to be additionally adhesively bonded.”

“The spacer is based on a hot-melt adhesive bonding agent. The hot-melt adhesive bonding agent is preferably solvent-free and is in a solid state of aggregation at room temperature. For application, the bonding agent has to be heated and transformed into a liquid state. The melting temperature of the hot-melt adhesive bonding agent as a constituent of the spacer is here of great significance. Depending on the material of the module, this may vary greatly. On the one hand, care must be taken to ensure that the melting point or melting range is not too low. The spacer must sensibly not undergo plastic deformation or even melt at storage or transport temperature, since the protective function of the spacer would thereby be severely impaired and could then at best only be used as a protective film.”

“On the other hand, the melting temperature should not be too high. On the one hand, the materials should not be too severely damaged by the temperature applied. Excessively high temperatures may lead to deformation as a result of thermal expansion, this being particularly pronounced with adhesive bonds in which the materials of the adhesively bonded substances have very different coefficients of expansion, such as for example in the metal/plastics combination. Heat-sensitive materials likewise restrict the possible melting temperature of the hot-melt adhesive bonding agent used. Particularly when using plastics, there is an upper limit to the temperature which can be used. It is thus advantageous, for example, to take care to ensure that the melting temperature of the spacer is below the softening temperature of the plastics.”

“The melting temperature of the hot-melt adhesive bonding agent preferably amounts to between 50° C. and 140° C., in particular between 55° C. and 120° C.”

“The hot-melt adhesive bonding agent of the spacer should be selected such that it adheres at least temporarily to the surface of the module and optionally to a surface to be adhesively bonded thereto. The adhesion of the spacers to the substrate is at least sufficient for them not to fall off through their intrinsic weight and other forces such as arise during stacking and during transportation of the modules.”

“From a chemical standpoint, in principle all materials known from hot-melt adhesive technology may be used. Particularly suitable are for example ethylene-vinyl acetate copolymers, polyolefins, in particular APAOs (Amorphous Poly-Alpha-Olefins), ethylene-ethyl acrylate copolymers, polyamides, polyesters, in particular polycaprolactone polyesters, polyurethane, in particular TPU (thermoplastic polyurethanes) and polycaprolactone polyurethanes and butadiene-styrene block copolymers. Mixtures of these polymers may also be used, wherein these may be mixtures within the same class or among the classes.”

“The spacer must be attached to a module surface and adhere thereto. The module surface may be of different material. The material particularly preferably comprises metals and plastics. The module is conventionally constructed from different materials. Particularly frequently, the surface of the module is finished. Such finishing may for example comprise a paint, a coating or a surface treatment. Examples of such finishing methods are ceramic coatings, powder coatings, anodization, zinc-rich primer, phosphating, chromating, sol/gel coatings, etc.”

“The module surface may be pretreated for adhesive bonding, if required. Such pretreatments include both chemical and physical pretreatments such as sanding, sand-blasting, brushing or the like, or treatment with cleaning products, solvents, adhesion promoters, adhesion promoter solutions or primers.”

“The spacer consists of a hot-melt adhesive bonding agent or contains a hot-melt adhesive bonding agent. However, it is advantageous for the proportion of the hot-melt adhesive bonding agent to constitute a substantial proportion by weight, preferably more than 70 wt. %, in particular more than 90 wt. %, relative to the weight of the spacer. Further constituents may for example be additives, tackifiers, adhesion promoters, fillers, UV screening agents, thermal insulants, biocides, fungicides, pigments, etc.”

“The spacer is preferably slightly resilient at least at the surface and does not have any sharp edges.”

“in a preferred embodiment, microwave-absorbing materials are constituents of the spacer. Preferred examples are on the one hand microwave-absorbing fillers and microwave-absorbing pigments, such as for example ferrite, cerium oxides, germanium oxides, carbon black, etc. So-called nanoparticles and/or carbon black are particularly preferred. The average particle size of these microwave-absorbing fillers and microwave-absorbing pigments is preferably under one micrometer, in particular under 100 nanometers.”

“In the case of a flat embodiment, the geometry of the spacer is advantageously cross-sectionally rectangular, triangular or trapezoidal. The spacer may also comprise a pore structure.”

“The spacer may be attached to the module in various ways. For example, on the one hand a spacer may be formed by an extrusion process or casting process. Such a spacer may be heated up during processing by a heat source in the area which is to undergo adhesive bonding with the module surface in such a way that at least the surface is partially or completely melted, and then positioned on the module surface. As a result of the melted spacer surface, the module surface is wetted, which leads to adhesion on cooling of the spacer. Alternatively, the module's surface may also be heated at least locally in the area of the intended adhesive bond to a temperature which is at or above the melting point of the spacer. Then, a spacer is positioned on the warm surface. Contact with the warm surface causes the spacer to melt or start to melt in the area of the contact surface.”

“On the other hand, for example, the spacer may also be applied directly as a melt to the module surface, for example by means of a nozzle. The cross section of the spacer may be determined by different nozzle shapes. In addition to bead-shaped spacers, spot-shaped spacers may also be produced in this way.”

“Heating of the spacer or of the module surface may be effected for example by means of infrared lamps, the supply of warm air, contacting with electrical heating elements or storage in the furnace. In the case of suitable metallic modular surfaces, induction heating may be used.”

“Whatever the heating processes, however, care must be taken to ensure that melting of the spacer is advantageously limited only to the area of the surface to be brought into contact with the module. This has the advantage that the distance brought about by the spacer between two modules is substantially uniform where all the spacers are identical, and may readily be predetermined by the dimensions of the spacer body used. This is particularly important when, as in an embodiment of the invention described in detail below, the spacer takes on the function of an adhesive spacer upon adhesive bonding of the module.”

To explain the method, EP 1 475 424 A1 contains a number of Figures, in particular FIG. 1. This makes it clear how the spacers of hot-melt adhesive are applied to the module to be adhesively bonded and how, in addition, the actual assembly adhesive is applied in the form of a bead of adhesive. EP 1 475 424 A1 explains this as follows:

“According to FIG. 1, a spacer 1 according to the invention is not removed on the production line, but rather remains in position on a module 2, here an automotive window pane. Assembly adhesive 3, for example one-component PU adhesive, is then applied to the module 2. Preferably, the assembly adhesive bead 3 is not interrupted by the hot-melt spacer 1, but rather includes the latter or extends within the spacer 1. In this way, the possibility of breaks in the seal arising subsequently at the joint between assembly adhesive and spacer is eliminated. Once the assembly adhesive has been applied, the spacers of hot-melt adhesive are melted. This process turns the spacers into a hot-melt fixing adhesive. This process may take place using the widest possible range of energy sources, preferably by IR radiation, a supply of hot air or particularly preferably by microwave radiation. Melting of the hot-melt spacers may also take place before or during application of the assembly adhesive The module with assembly adhesive and the spacer with molten hot-melt fixing adhesive is then installed/pressed manually or automatically, e.g. using a robot, into the article to be produced. The hot-melt fixing adhesive, as well as the assembly adhesive, wet the adhesive surface of the mating component. As a result of cooling, the hot-melt fixing adhesive quickly solidifies and builds up adhesion to the substrate. Adhesion is then at least such that the module is fixed in its position until the actual assembly adhesive has built up sufficient strength and is capable of holding the module firmly in its position. In this assembly method, fixing aids such as adhesive tapes, wedges or clamps are no longer necessary, which offers a decisive advantage. The spacers thus no longer have to be removed and disposed of after use, but rather change their function to that of a fixing adhesive. Additional fixing aids are thus also no longer necessary, which is a further considerable advantage.”

According to these explanations, the hot-melt fixing adhesive (thus the hot-melt adhesive) is melted prior to adhesive bonding of the module to the receiving unit by heating. This may take place, according to the passage from EP 1 475 424 A1 cited above, “using the widest possible range of energy sources, preferably by IR radiation, a supply of hot air or particularly preferably by microwave radiation.” This has processing disadvantages. Melting by microwave radiation, which is particularly preferred, requires the hot-melt adhesive to contain components such as for example pigments which can absorb microwave radiation and in this way be heated. These necessary components make the hot-melt adhesive more expensive and restrict formulation options therefor. If the microwave-absorbing components are distributed uniformly in the hot-melt adhesive, the entire volume of the latter is heated and melts. In this way, the entire mass of hot-melt adhesive is softened, which makes positioning of the module more difficult. However, it is complex to introduce the microwave-absorbing components only into the peripheral zone of the hot-melt adhesive actually requiring melting, which makes the production process more expensive.

Similar problems arise where the hot-melt adhesive is melted by IR radiation or supply of hot air. It is also difficult in this case to limit melting of the hot-melt adhesive to the boundary layer actually requiring adhesive bonding and so to ensure dimensionally accurate positioning of the component to be bonded in place.

### BRIEF SUMMARY OF THE INVENTION

The present invention builds on the method according to EP 1 475 424 A1 to the effect that melting of the hot-melt adhesive upon bonding of the first component to the second component is limited to a boundary area of the hot-melt adhesive. Uncontrolled softening of relatively large areas or even of the entire hot-melt adhesive is avoided, whereby adhesive bonding of the first component to the second component by a glueline of predetermined thickness is simplified. In addition, the hot-melt adhesive does not have to contain any radiation-absorbing components, since it does not have to be melted through the action of radiation.

The present invention accordingly provides a method of adhesively bonding a first component to a second component which comprises a peripheral zone to which the first component is adhesively bonded in overlapping manner, wherein:

a) at least one body of hot-melt adhesive is adhesively bonded to the first component in such a way that it comes into contact with the peripheral zone upon adhesive bonding of the first component to the second component,

b) the peripheral zone is heated locally at at least one point, at which the applied body of hot-melt adhesive comes into contact with the peripheral zone upon adhesive bonding of the first component, indirectly or directly by electromagnetic induction to a temperature above the melting temperature of the hot-melt adhesive,

c) the first component is brought into contact with the peripheral zone of the second component in such a way that the body of the hot-melt adhesive comes into contact with the point of the peripheral zone heated in step b), such that the hot-melt adhesive melts at the point of contact with the peripheral zone and bonds the first component to the peripheral zone of the second component after cooling,

d) wherein, in addition, prior to step b) or after step c) a reactive adhesive is introduced in such a way between the first and the second component that it bonds the first component to the peripheral zone of the second component, and

e) the reactive adhesive is cured or allowed to cure.

The essential difference from the above-cited prior art thus consists in the fact that at least one point of the peripheral zone of the second component, to which the first component is adhesively bonded, is heated indirectly or directly by electromagnetic induction to a temperature above the melting temperature of the hot-melt adhesive. When the first component with its body located thereon of hot-melt adhesive is brought into contact with the peripheral zone of the second component, the hot-melt adhesive melts at the heated points in a peripheral zone without softening the entire hot-melt adhesive. The depth to which melting takes place may be controlled in that the peripheral zone of the second component is heated locally to a temperature which lies above the melting temperature of the hot-melt adhesive by a predetermined amount. Advantageously, the peripheral zone of the second component is heated to a temperature which lies 10 to 30° C. above the melting temperature of the hot-melt adhesive. Heating by electromagnetic induction makes it possible to adjust the temperature to which points of the peripheral zone of the second component are heated precisely to ±10° C., or even to ±5° C. Preferably the temperature to which points of the peripheral zone of the second component are heated and the melting point of the hot-melt adhesive are matched to one another in such a way that a peripheral layer of the hot-melt adhesive of a thickness of 1 to 2 mm is melted on contact of the hot-melt adhesive with the peripheral zone.

No radiant energy is thus introduced into the hot-melt adhesive itself, such that the latter does not have to contain any components which are able to absorb radiant energy, such as for example microwave energy.

### DETAILED DESCRIPTION OF CERTAIN EMBODIMENTS OF THE INVENTION

In the method according to the invention, the peripheral zone is thus heated locally at those points which are intended to come into contact with the hot-melt adhesive to a temperature above the melting temperature of the hot-melt adhesive. The hot-melt adhesive thus melts at the boundary area with the surface of the peripheral zone in that it comes into contact with the heated points of the peripheral zone. The heated points of the peripheral zone have a temperature which lies above the melting temperature of the hot-melt adhesive. This has the consequence that the hot-melt adhesive has a particularly good wetting action and adheres particularly well to the peripheral zone after cooling. In contrast, wetting is poorer and adhesion less effective if the hot-melt adhesive is initially heated and then brought into contact with the peripheral zone, whose temperature is below the melting temperature of the hot-melt adhesive. The hot-melt adhesive then solidifies rapidly at the contact point, without wetting the peripheral zone sufficiently.

Local heating of the peripheral zone to a temperature which lies above the melting temperature of the hot-melt adhesive results in good adhesion of the hot-melt adhesive even on oily parts. On the one hand, the oil partially evaporates on heating, before coming into contact with the hot-melt adhesive. On the other hand, the remaining oil is also heated to a temperature lying above the melting temperature of the hot-melt adhesive. This improves absorption of the oil into the hot-melt adhesive and removal from the boundary surface, such that it does not have a disadvantageous effect on adhesion.

The size of the particular area of the peripheral zone, which is heated before, during or after contact with the hot-melt adhesive, depends on the size of the contact surface of the hot-melt adhesive. In general, it is sufficient for the heated area, where said area is circular, to have a diameter in the range from 5 to 20 mm, in particular from 8 to 15 mm. For polygonal, for example square, areas, this may be recalculated accordingly. If appropriate power is input (preferably in the range from 300 to 1000 watts), a heating period in the range from 1 to 10 seconds is generally sufficient to reach a temperature above the melting temperature of the hot-melt adhesive. During this heating time or immediately thereafter, the hot-melt adhesive should be brought into contact with the heated points. Since less heat is dissipated during this short time period, heating may be very well localized.

Local heating of the peripheral zone may take place “from below” or “from above”. “Below” means the opposite side of the peripheral zone from the surface which comes into contact with the hot-melt adhesive. “Above” means that side which comes into contact with the hot-melt adhesive. This applies in particular to metallic peripheral zones, which are heated directly by electromagnetic induction. In the case of heating “from below”, the inductor is brought to that point on the underside of the peripheral zone which is opposite the point of contact with the hot-melt adhesive. Directly before, or while the upper side is coming into contact with the hot-melt adhesive, the corresponding point of the peripheral zone is heated from below by electromagnetic induction. If the first component is not metallic and therefore not itself heatable by electromagnetic induction, local heating of the peripheral zone directly before or during contact with the hot-melt adhesive may also take place “from above”. The inductor is then brought to that point of the first component which is opposite the point of contact thereof with the hot-melt adhesive. When the electromagnetic alternating field is switched on, this penetrates the first component and the hot-melt adhesive, without heating them significantly, and, through electromagnetic induction, heats that point of the peripheral zone which is intended to come into contact or is in contact with the hot-melt adhesive. This latter procedure will be selected in particular when it is impossible on spatial grounds to bring the inductor up to the rear of the peripheral zone. Irrespective of the procedure selected, it is preferable to provide as many inductors for local heating of the peripheral zone as there are hot-melt adhesive bodies attached to the first component. In this way, all the hot-melt adhesive bodies may be bonded simultaneously to the second component.

As also described in EP 1 475 424 A1, the reactive adhesive, which ultimately ensures the strength of the bond between first and second component, may be introduced in various ways into the gap between first and second component. The first alternative consists in applying the reactive adhesive as step d) in such a way to the first component prior to step b) that it comes into contact with the peripheral zone of the second component upon adhesive bonding of the first component to the second component in step c). This may take place for example in the form of an adhesive bead, which is applied continuously to that peripheral zone of the first component which, upon adhesive bonding with the second component, rests on the peripheral zone thereof. Preferably, this adhesive bead is applied in such a way that it is guided around the body of the hot-melt adhesive without touching it. This corresponds to the method illustrated in FIG. 1 of EP 1 475 424 A1.

Alternatively, the reactive adhesive is not applied to the first component, but rather to the peripheral zone of the second component. This also ideally takes place in the form of an adhesive bead, which is set in place in such a way that those points of the peripheral zone which are indirectly or directly heated inductively prior to insertion of the first component and come into contact with the hot-melt adhesive body may be avoided. This alternative is thus characterized in that the reactive adhesive is applied as step d) in such a way onto the peripheral zone of the second component prior to step b) that it comes into contact with the first component upon adhesive bonding of the first component to the peripheral zone of the second component, those points of the peripheral zone which come into contact with the body of hot-melt adhesive in the subsequent step c) remaining free of reactive adhesive.

A third, but more complex alternative comprises introducing the reactive hot-melt adhesive into the gap remaining between the first component and the peripheral zone of the second component only after step c).

The body of hot-melt adhesive, which is initially adhesively bonded to the first component, is preferably so shaped that it comprises two at least approximately parallel areas, wherein the first of the parallel areas come into contact with the first component and the second of the parallel areas come into contact with the peripheral zone of the second component. Adhesive bonding of the hot-melt adhesive body to the first component preferably takes place in that it is melted at the area to be adhesively bonded, pressed against the first component and allowed to solidify by cooling. The bodies of hot-melt adhesive may be produced for example by injection into a corresponding mold or by extrusion and cutting up. To simplify manufacture, the bodies of hot-melt adhesive preferably have the shape of a round or polygonal disk or column. A “disk” is understood to mean a body whose height is less than the diameter of the base area. Conversely, a “column” describes a body whose height is greater than or equal to the diameter of the base area. The “base area” is that area with which the hot-melt adhesive body is adhesively bonded to the first component. The disk or column may for example be triangular, quadrilateral (in particular square or rectangular, but also trapezoidal), pentagonal or hexagonal.

The diameter of the base area is preferably in the range from 5 to 15 mm, in particular in the range from 8 to 12 mm. In the case of base areas which are not round, “diameter” means the longest diagonal of the base area. The height of the body depends on the desired gap which needs to be bridged. It should be noted here that height is lost through partial melting of the areas to be adhesively bonded. The height of the body of hot-melt adhesive should therefore amount to at least 4 mm before adhesion. In practice, however, a height of more than 10 to 20 mm ought not to be necessary.

The bodies of hot-melt adhesive may however also be spherical prior to bonding with the first component. On bonding with the first component, the sphere is flattened at the contact point, in an extreme case virtually to the point of producing a hemisphere. On bonding with the peripheral zone of the second component, the corresponding contact point of the former sphere is likewise flattened, such that the hot-melt adhesive approximately adopts the shape of a round disk after bonding of the first component to the peripheral zone of the second component.

If the first component is metallic, this may be heated directly by electromagnetic induction, before it comes into contact with the hot-melt adhesive body or while it is in contact therewith. This may take place in a manner similar to that described above for local heating of the peripheral zone of the second component.

However, if the first component is not metallic (for example glass, wood or plastic), it is preferably heated indirectly by electromagnetic induction. This will be examined below.

Hot-melt adhesives which may be used as the hot-melt adhesive are those known from the prior art and described, for example, in EP 1 475 424 A1. For example, the hot-melt adhesive may contain or consist of one or more of the following components: polyolefin, ethylene/vinyl acetate copolymer, ethylene/ethyl acrylate copolymer, polyamide, polyester, polyurethane, butadiene/styrene block polymer. Those hot-melt adhesives which are listed in paragraph [0027] of EP 1 475 424 A1 are preferred.

If the first component consists of glass at least at the point to which the body of the hot-melt adhesive is adhered, it is preferable to use a hot-melt adhesive which is optimized for adhesion to glass. Hot-melt adhesives which may, for example, be considered for this purpose are those which contain or consist of one or more of the following components:

cycloaliphatic hydrocarbon resin;

copolymer of styrene with isoprene and/or a-methylstyrene, which may optionally be hydrogenated;

hydrogenated polydecene;

copolymer of maleic anhydride with ethylene and/or propylene.

A hot-melt adhesive which is particularly suitable for this purpose contains (in wt. % relative to the entire hot-melt adhesive):

cycloaliphatic hydrocarbon resin in quantities of from 20 to 30 wt. %;

copolymer of styrene with isoprene and/or α-methylstyrene, which may optionally be hydrogenated, in quantities of from 20 to 40 wt. %;

hydrogenated polydecene in quantities of from 10 to 20 wt. %;

copolymer of maleic anhydride with ethylene and/or propylene in quantities of from 25 to 35 wt. %.

In addition, further components may be present in an overall quantity of up to 10 wt. %, for example styrene/ethylene/butylene copolymer, which is preferably used in quantities of from 1 to 8 wt. %.

The proportions of the individual components here add up to 100 wt. %.

In the method according to the invention, further classes of hot-melt adhesive may also be used.

Suitable hot-melt adhesives may, for example, be based on polyesters, polyurethanes, polyolefins, polyacrylates or polyamides. Hot-melt adhesives based on polyesters are described for example in EP 028687. These are reaction products of aliphatic, cycloaliphatic or aromatic dicarboxylic acids, which may be reacted with aliphatic, cyclic or aromatic polyols. Crystalline or partially crystalline polyesters may be obtained by suitable selection of the carboxylic acids and the polyols. Conventionally, dicarboxylic acids and diols are caused to react with one another. However, it is also possible to use proportions of tricarboxylic acids or triols.

EP 434467 and DE 4128274 describe thermoplastic polyurethanes as hot-melt adhesives. These are reaction products of polyols with polyisocyanates, which optionally have a high modulus. The polyols used may be per se known polyols based on polyethers, polyesters, polyacrylates, polybutadienes, polyols based on vegetable raw materials or oleochemical polyols. To achieve good reactivity, at least proportions of aromatic isocyanates are conventionally included. The properties of the prepolymers, for example melting point, elasticity or adhesion, may be influenced by suitable selection of the polyols and/or isocyanates. Reactive thermoplastic polyurethanes are, however, also suitable, which may then be optionally also be permanently crosslinked after application.

Examples of further suitable hot-melt adhesives are polyamides. Suitable polyamides are described in EP 749463, for example. These are polyamide hot-melt adhesives based on dicarboxylic acids and polyether diamines. Particularly suitable hot-melt adhesive compositions are described in EP 204 315. These are polyester amides which are produced on the basis of polymeric fatty acids and polyamines.

Polyamides may for example be selected which are based on polyamides containing no dimeric fatty acids. These may be made from
40 to 50 mol %, preferably 50 mol %, of one or more C₄-C₁₈ dicarboxylic acid(s)
5 to 45 mol %, preferably 15 to 40 mol %, of at least one aliphatic diamine
5 to 40 mol %, preferably 20 to 30 mol %, of one or more cycloaliphatic diamines
0 to 40 mol %, preferably 5 to 25 mol %, of polyether diamines,
   the total of the diamines used in one preferred embodiment amounting to 50 mol %, such that the dicarboxylic acid component and the diamine component are present in approximately equivalent molar proportions.

However, the dicarboxylic acids are preferably used in up to 10% stoichiometric excess relative to the diamines, such that carboxyl-terminated polyamides are obtained. The molecular weight of the polyamides to be used according to the invention amounts to approx. 10,000 to 50,000, preferably 15,000 to 30,000. These polyamides suitable according to the invention may have a viscosity of between 5000 and 60,000 mPa·s, preferably between 15,000 and 50,000 mPa·s (measured at 200° C., Brookfield Thermosel RVT, EN ISO 2555).

Examples of dicarboxylic acids for producing polyamides according to the invention are in particular adipic acid, azelaic acid, succinic acid, dodecanedioic acid, glutaric acid, suberic acid, maleic acid, pimelic acid, sebacic acid, undecanedioic acid or mixtures thereof.

The diamine component substantially consists of one or more aliphatic diamines, preferably with an even number of carbon atoms, the amino groups being at the ends of the carbon chains. The aliphatic diamines may contain 2 to 20 carbon atoms, wherein the aliphatic chain may be linear or slightly branched. Specific examples are ethylenediamine, diethylenetriamine, dipropylenetriamine, 1,4-diaminobutane, 1,3-pentanediamine, methylpentanediamine, hexamethylenediamine, trimethylhexamethylenediamine, 2-(2-aminomethoxy)ethanol, 2-methylpentamethylenediamine, C₁₁-neopentanediamine, diaminodipropylmethylamine, and 1,12-diaminododecane. Particularly preferred aliphatic diamines are C₄-C₁₂ diamines with an even number of C atoms.

The amino component may additionally contain cyclic diamines or heterocyclic diamines such as for example 1,4-cyclohexanediamine, 4,4′-diamino-dicyclohexylmethane, piperazine, cyclohexane-bis-(methylamine), isophoronediamine, dimethylpiperazine, dipiperidylpropane, norbornanediamine or m-xylylenediamine.

If the polyaminoamide needs to have a relatively high flexibility, polyoxyalkylenediamines such as for example polyoxyethylenediamines, polyoxypropylenediamines or bis-(di-aminopropyl)-polytetrahydrofuran may additionally also be used. Polyoxyalkylenediamines are particularly preferred. Their molecular weight is preferably between 200 and 4000.

Furthermore, aminocarboxylic acids or their cyclic derivatives may also be used. Mention may here be made for example of 6-aminohexanoic acid, 11-aminoundecanoic acid, laurolactam, and ε-caprolactam.

A further embodiment of the hot-melt adhesive which is suitable according to the invention contains a polyamide based on dimerized fatty acid as an essential component. Dimerized fatty acids are obtained by coupling unsaturated long-chain monobasic fatty acids, e.g., linolenic acid or oleic acid. The acids have long been known and are commercially available.

The polyamides usable according to the invention are for example composed of
35 to 49.5 mol % of dimerized fatty acid; and
0.5 to 15 mol % of monomeric fatty acid with 12 to 22 C atoms; and
2 to 35 mol % of polyetherdiamines of the general formula

H₂N—R⁵—O—(R⁶O)ₓ—R⁷—NH₂, (I)

in which:
x denotes a number between 8 and 80, in particular between 8 and 40;
R⁵ and R⁷ denote identical or different aliphatic and/or cycloaliphatic hydrocarbon residues with preferably 2 to 8 C atoms; and
R⁶ denotes an optionally branched aliphatic hydrocarbon residue with 1 to 6 C atoms,
   and
15 to 48 mol % of aliphatic diamines with 2 to 40 C atoms, wherein up to 65% of the dimerized fatty acids may be replaced by aliphatic dicarboxylic acids with 4 to 12 carbon atoms.

Another suitable composition may be obtained from
20 to 49.5 mol % of dimerized fatty acid; and
0.5 to 15 mol % of monomeric fatty acid with 12 to 22 C atoms; and
20 to 55 mol % of an amine with 2 to 40 C atoms bearing at least 2 primary amino groups;
wherein up to 65% of the dimerized fatty acids may be replaced by aliphatic dicarboxylic acids with 4 to 12 carbon atoms.

With regard to the amine components in the polyamides, polyetherpolyols with primary amino end groups as already listed above are preferably suitable. In this regard, preferred polyether polyols with amino end groups are those which are not or are only slightly water-soluble. The polyether polyols with amino end groups which are used in particular have molecular weights of between 700 and 2500 g/mol. A particularly suitable class of raw materials comprises, for example, bis-(3-aminopropyl)-polytetrahydrofurans.

Furthermore, primary alkylenediamines with 2 to 10 C atoms may in particular also be used, selected from the above-stated amines.

A further suitable class of diamines is derived from dimeric fatty acids and contains primary amino groups instead of the carboxyl groups. Such substances are frequently known as dimer diamines. They are obtained from the dimerized fatty acids by nitrile formation and subsequent hydrogenation.

The above-listed aliphatic dicarboxylic acids may be used as carboxylic acids. Suitable aliphatic carboxylic acids preferably have 4 to 12 C atoms. These acids may replace up to 65% of the dimer fatty acid in molar terms. Long-chain aminocarboxylic acids such as 11-aminoundecanoic acid or also lauryl lactam may additionally be used.

It is known in this respect to a person skilled in the art that the melting point of the polyamides may be increased within certain limits by the addition of sebacic acid. The polyamide raw materials such as for example caprolactam known in fiber chemistry may also be used in small quantities. These substances allow a person skilled in the art to increase the melting point within certain limits.

When selecting the monofunctional, difunctional or trifunctional raw materials to be used, it must be ensured that meltable, i.e., uncrosslinked, products, are obtained. For example, if crosslinking/gelation occur as a result of lowering the proportion of trifunctional components (trimeric fatty acids) and/or increasing the content of monofunctional amines or fatty acids, polymers may be obtained which have a tendency not to gel.

In general, the quantities of amine and carboxylic acid are so selected that the polyamides comprise 1-120 meq of carboxyl groups per kg of solids, in particular between 10 and 100 meq/kg. Alternatively, it is also possible to work with an excess of amines. An amine content of between 1 and 140 meq/kg solids, in particular of between 10 and 100 meq/kg, should then be obtained. The molecular weight (measured as number average molecular weight, as is obtainable using GPC) may amount to between 30,000 and 300,000 g/mol, in particular between 50,000 and 150,000 g/mol. The viscosity of the polyamides should amount to between 5000 and 100,000 mPa·s (measured at 200° C.), in particular up to 50,000 mPa·s.

Further suitable systems may comprise copolymers of ethylene and vinyl acetate. Such copolymers are known and commercially available. They preferably contain 14-40% vinyl acetate. The melt flow index is between 25 and 2500.

Furthermore, the hot-melt adhesives suitable according to the invention may contain further conventional additives. Examples thereof are tackifying resins, such as for example abietic acid, abietic acid esters, terpene resins, terpene/phenolic resins or hydrocarbon resins; fillers, e.g., silicates, talcum, calcium carbonates, clays, carbon black or pigments; antioxidants or stabilizers, e.g., of the sterically hindered phenol or aromatic amine derivative type; fibrous additives, such as natural fibers, plastics or glass fibers. The antioxidants may be used in quantities of up to 1.5 wt. % relative to the polymers. In general, these additives may be present in a hot-melt adhesive according to the invention in an amount of no more than 15 wt. % in total.

Preferably, the hot-melt adhesive is selected such that it melts at a temperature of at least 50° C., in particular of at least 55° C., but of at most 220° C., in particular of at most 180° C. A particularly preferred hot-melt adhesive is one which melts above 120° C., in particular in the range from 130 to 150° C.

Preferably, the hot-melt adhesive is matched to the reactive adhesive in such a way that both adhesives have a similar, preferably identical rigidity, after solidification or curing. The two types of adhesive then correspond in terms of mechanical load-bearing capacity. The rigidity of the hot-melt adhesive should at least not be any greater than that of the cured reactive adhesive, since it is otherwise the hot-melt adhesive which preferentially breaks under load. Although this is insignificant with regard to the strength of the bond between first and second component, on inspection it gives the impression of “failure”.

An adhesive which may be used as the reactive adhesive may be one such as has hitherto been used in the prior art for corresponding adhesive bonding of a first and a second component. For example, a single-component polyurethane adhesive, an epoxy resin adhesive, an acrylate adhesive or sealant or a silicone adhesive or sealant may be used as the reactive adhesive. The reactive adhesive may also be a two-component reaction adhesive.

A single body of hot-melt adhesive is not generally sufficient to bond the first component sufficiently firmly to the second component before the reactive adhesive cures. On the other hand, it is unnecessary and uneconomic to use too many bodies of hot-melt adhesive. How many bodies of hot-melt adhesive are used per first component depends in particular on the size and weight thereof and has optionally to be established by preliminary testing. As a rule it is sufficient to adhesively bond 2 to 20, preferably 4 to 16, bodies of hot-melt adhesive to the first component before the latter is adhesively bonded to the second component. In the case of very large first components, however, it may also be necessary to use more than 20 bodies of hot-melt adhesive per component. Preferably, the bodies of hot-melt adhesive are applied to the first component in the region of mutually opposing corners and/or edges thereof.

In accordance with the teaching of EP 1 475 424 A1, the bodies of hot-melt adhesive may be adhered to the first component before the latter is warehoused and/or transported. This means that the manufacturer of the first component may provide the latter with the bodies of hot-melt adhesive before the first component is conveyed to another production site, where it is adhesively bonded to the second component. In this case, the bodies of hot-melt adhesive additionally take on the function of spacers, as described in EP 1 475 424 A1.

With regard to efficient production, however, it may also be preferable not to apply the bodies of hot-melt adhesive onto the first component until directly prior to adhesive bonding of the first component to the second component. In this embodiment, the bodies of hot-melt adhesive are adhered to the first component in a manner related space- and timewise with the adhesive bonding of the first component to the second component. This may take place, for example, in that the first component provided for adhesive bonding is gripped with a handling device such as for example the arm of a robot, the body(ies) of hot-melt adhesive then being adhered to the first component (which may likewise be performed by a robot) and the first component subsequently being brought into contact with the second component by the same handling device without being put down in the meantime. Adhesion of the hot-melt adhesive bodies to the first component and adhesive bonding of the first component to the second component thus takes place more or less in a single production step using the same robot. It goes without saying that the reactive adhesive is likewise applied within this production step either onto the first component or onto the second component or into the gap between first and second component.

One embodiment of the method according to the invention is characterized in that the second component is metallic at least in the peripheral zone and the peripheral zone is heated directly by electromagnetic induction locally at at least one point at which, on adhesive bonding of the first component, the applied body of hot-melt adhesive comes into contact with the peripheral zone. To this end, a magnetic alternating field is caused to act on the points of the peripheral zone to be heated.

In an alternative embodiment, the procedure is such that the peripheral zone of the second component is heated indirectly by electromagnetic induction locally at at least one point at which, on adhesive bonding of the first component, the applied body of hot-melt adhesive comes into contact with the peripheral zone, this being effected by heating at least one at least partially metallic heating element by electromagnetic induction and bringing it into contact with the peripheral zone.

In this embodiment, therefore, the magnetic alternating field, which brings about electromagnetic induction, does not act directly on the peripheral zone of the second component in order to heat it. Therefore, this embodiment is not only suitable for second components with a metallic peripheral zone but also for nonmetallic second components. In this embodiment, the magnetic alternating field is not caused to act directly on the peripheral zone of the second component but rather on a separate heating element, which is at least partially metallic. For example, this heating element may be a plastics bolt, which is provided with a metal foil at least at that end which is brought into contact with the second component. This metal foil is heated inductively and positioned on the peripheral zone of the component.

A device may here be used which is similar to the one described in greater detail in German Utility Model DE 203 00 624 U1. This document describes a device which comprises a “hand part”, which comprises or contains an induction means. For the method according to the invention, this means is preferably modified in such a way that one or more heating means corresponding to this “hand part” are provided, which are attached to the handling device for insertion or positioning of the first component. For the first process variant, the heating element may here constitute an electromagnetic induction device, by means of which the metallic peripheral zone of the second component is heated directly by electromagnetic induction of currents. In the second embodiment, the heating element likewise contains a device for electromagnetic induction. The heating element additionally includes a metallic element, which is heated by electromagnetic induction and which is in turn used for local heating of the peripheral zone of the second component, the metallic element being brought into contact with the peripheral zone of the second component. In this case, a nonmetallic resilient bolt is preferably provided, which may consist for example of silicone, onto whose end face facing the substrate a metal foil is applied. This metal foil is heated by electromagnetic induction. Upon positioning on the substrate to be heated, as a result of its resilience, the bolt adapts well to the substrate surface, such that even slightly curved substrates may be locally heated. This procedure may be used in particular for the purpose of adhesively bonding the hot-melt adhesive body to a nonmetallic first or second component. For example, the hot-melt adhesive body may in this way be positioned on a pane of glass, before the latter is adhesively bonded with a metallic peripheral zone of a second component.

Conveniently, the handling device which positions the first component on the second component or inserts the former in the latter comprises one or more heating means, with which in step b) the peripheral zone of the second component may be heated indirectly or directly by electromagnetic induction locally at at least one point at which, on adhesive bonding of the first component, the applied body of hot-melt adhesive comes into contact with the peripheral zone. Preferably, the handling device comprises as many heating means as there are hot-melt adhesive bodies adhered to the first component. The same handling device which positions the first component on the second component or inserts the former into the latter is thus also used to heat inductively the peripheral zone of the second component at those points at which the bodies of hot-melt adhesive are positioned directly before contact is brought about. This integrated procedure enables particularly short cycle times, since only small areas of material have to be heated.

The method according to the invention is not restricted to particular first and second components. For example, the first component may be a glass or plastics sheet, in particular a window pane for a vehicle. The method according to the invention is thus particularly suitable for direct glazing of vehicles. Furthermore, the first component may be a plastics or wooden panel. The first and second components may also each be a metal sheet, requiring preliminary fixing before a reactive adhesive is used to produce a flanged seam bonded joint. This may be performed, for example, to produce a vehicle door.

The second component may quite generally be a shell or shell part of an architectonic structure, a piece of furniture, a device such as, for example, a household or industrial machine or a motor vehicle or aircraft or a ship.

The procedure according to the invention may increase production speed compared with the prior art. It improves the precision with which the first component is adhesively bonded to the second, since manufacturing tolerances are reduced by better control of melting of the hot-melt adhesive only in the peripheral zone to be adhesively bonded.

What is claimed is:

1. A method of adhesively bonding a first component to a second component, which comprises a peripheral zone with which the first component is adhesively bonded in overlapping manner, wherein:
a) at least one body of hot-melt adhesive is adhesively bonded to the first component in such a way that said at least one body of hot-melt adhesive comes into contact with the peripheral zone upon adhesive bonding of the first component to the second component;
b) the peripheral zone is heated locally at at least one point, at which the applied body of hot-melt adhesive comes into contact with the peripheral zone upon adhesive bonding of the first component, indirectly or directly by electromagnetic induction to a temperature above the melting temperature of the hot-melt adhesive;
c) the first component is brought into contact with the peripheral zone of the second component in such a way that the body of the hot-melt adhesive comes into contact with the point of the peripheral zone heated in step b), such that the hot-melt adhesive melts at the point of contact with the peripheral zone and bonds the first component to the peripheral zone of the second component after cooling;
d) wherein, in addition, prior to step b) or after step c) a reactive adhesive is introduced in such a way between the first and the second component that said reactive adhesive bonds the first component to the peripheral zone of the second component; and
e) the reactive adhesive is cured or allowed to cure.

2. The method as claimed in claim 1, wherein said reactive adhesive is applied in step d) in such a way to the first component prior to step b) that said reactive adhesive comes into contact with the peripheral zone of the second component upon adhesive bonding of the first component to the second component in step c).

3. The method as claimed in claim 1, wherein said reactive adhesive is applied in step d) in such a way onto the peripheral zone of the second component prior to step b) that said reactive adhesive comes into contact with the first component upon adhesive bonding of the first component to the peripheral zone of the second component, those points of the peripheral zone which come into contact with the body of hot-melt adhesive in the subsequent step c) remaining free of reactive adhesive.

4. The method as claimed in claim 1, wherein said reactive adhesive is introduced in step d) into a gap between the first component and the peripheral zone of the second component after step c).

5. The method as claimed in claim 1, wherein said reactive adhesive is applied or introduced in the form of an adhesive bead.

6. The method as claimed in claim 1, wherein said body of hot-melt adhesive is formed from a hot-melt adhesive in such a way that said body comprises two at least approximately parallel areas, the first of the parallel areas coming into contact with the first component and the second of the parallel areas coming into contact with the peripheral zone of the second component.

7. The method as claimed in claim 1, wherein said body of hot-melt adhesive takes the form of a round or polygonal disk or column.

8. The method as claimed in claim 1, wherein the hot-melt adhesive comprises one or more components selected from the group consisting of polyolefins, ethylene/vinyl acetate copolymers, ethylene/ethyl acrylate copolymers, polyamides, polyesters, polyurethanes, and butadiene/styrene block polymers.

9. The method as claimed in claim 1, wherein the hot-melt adhesive comprises one or more components selected from the group consisting of cycloaliphatic hydrocarbon resins, copolymers of styrene with isoprene and/or a-methylstyrene, hydrogenated copolymers of styrene with isoprene and/or a-methylstyrene, hydrogenated polydecenes, and copolymers of maleic anhydride with ethylene and/or propylene.

10. The method as claimed in claim 1, wherein the hot-melt adhesive melts at a temperature of at least 50° C. and at most 180° C.

11. The method as claimed in claim 1, wherein the reactive adhesive is selected from the group consisting of single-component polyurethane adhesives, epoxy resin adhesives, acrylate adhesives, acrylate sealants, silicone adhesives, silicone sealants and two-component reactive adhesives.

12. The method as claimed in claim 1, wherein 2 to 20 bodies of hot-melt adhesive are adhesively bonded to the first component, before the first component is adhesively bonded to the second component.

13. The method as claimed in claim 1, wherein the first component is warehoused and/or transported after adhesive bonding of the body(ies) of hot-melt adhesive and prior to adhesive bonding to the second component.

14. The method as claimed in claim 1, wherein the first component is gripped with a handling device, the body(ies) of hot-melt adhesive then being adhered to the first component and the first component subsequently being brought into contact with the second component by the same handling device without being put down in the meantime.

15. The method as claimed in claim 14, wherein the handling device comprises one or more heating means, with which in step b) the peripheral zone of the second component may be heated indirectly or directly by electromagnetic induction locally at at least one point at which, on adhesive bonding of the first component, the applied body of hot-melt adhesive comes into contact with the peripheral zone.

16. The method as claimed in claim 1, wherein the second component is metallic at least in the peripheral zone and the peripheral zone is heated directly by electromagnetic induction locally at at least one point at which, on adhesive bonding of the first component, the applied body of hot-melt adhesive comes into contact with the peripheral zone.

17. The method as claimed in claim 1, wherein the peripheral zone of the second component is heated indirectly by electromagnetic induction locally at at least one point at which, on adhesive bonding of the first component, the applied body of hot-melt adhesive comes into contact with the peripheral zone, this being effected by heating at least one at least partially metallic heating element by electromagnetic induction and bringing said at least one at least partially metallic heating element into contact with the peripheral zone.

18. The method as claimed in claim 1, wherein the first component is selected from the group consisting of sheets of glass, sheets of plastic, plastic panels, and wooden panels.

19. The method as claimed in claim 1, wherein the second component is a shell or shell part of an architectonic structure, a piece of furniture, a device, a vehicle, an aircraft or a ship.
